(19) United States
(12) Patent Application Publication
(10) Pub. No.: US 2013/0009494 A1
(43) Pub. Date: Jan. 10, 2013

(54) MOTOR AND METHOD OF MANUFACTURING MOTOR

(75) Inventor: Yoshiaki OGUMA, Kyoto (JP)

(73) Assignee: NIDEC CORPORATION, Kyoto (JP)

(21) Appl. No.: 13/473,709

(22) Filed: May 17, 2012

(30) Foreign Application Priority Data
Jul. 5, 2011 (JP) 2011-149583

(51) Int. Cl. H02K 1/27; H02K 15/03

(52) U.S. Cl. 310/43; 29/598

(57) ABSTRACT

A rotating portion of a motor includes a rotor holder including a cylindrical portion arranged to be coaxial or substantially coaxial with a central axis, a plurality of magnets arranged in a circumferential direction on an inner circumferential surface of the cylindrical portion, and a resin portion arranged on a surface of the rotor holder. The resin portion includes a plurality of ribs arranged at regular or substantially regular intervals in the circumferential direction along the inner circumferential surface of the cylindrical portion, and an outer tubular portion arranged to cover an outer circumferential surface of the cylindrical portion. Each rib and the outer tubular portion are arranged to be defined by a single monolithic member such that each rib and the outer tubular portion are continuous with each other. Each magnet is preferably arranged between a separate pair of adjacent ones of the ribs.

### BACKGROUND OF THE INVENTION

1. Field of the Invention

The present invention relates to a motor and a method of manufacturing the motor.

2. Description of the Related Art

Outer-rotor motors, in which magnets are arranged to rotate outside of coils, are known. Some outer-rotor motors use an annular magnet in which north and south poles are arranged alternately in a circumferential direction, while other outer-rotor motors use a plurality of plate-shaped magnets arranged in the circumferential direction. The use of a plurality of plate-shaped magnets is particularly prevalent in motors, such as fan motors, of which improved efficiency is demanded, in view of reduced losses in a magnetic circuit and an ease in manufacturing the magnets.

An example of such a conventional motor including a plurality of plate-shaped magnets is described, for example, in JP-A 2000-69697.

In the case of a motor using a plurality of plate-shaped magnets, it is desirable that the magnets should be arranged at regular intervals in the circumferential direction in order to achieve circumferentially regular pole changes. However, in the case where each of the plurality of magnets is simply fixed through an adhesive, adjacent ones of the magnets may, for example, be attracted to each other which thereby makes it difficult to position each magnet at a desired circumferential position. Accordingly, a known method uses a jig to fix each magnet at a position where the magnet is to be adhered. However, with this known method, an operation of adhering the magnets is cumbersome.

In such a connection, in the motor described in JP-A 2000-69697, rotor magnets, a frame, and a ring member are united through a resin (for example, see claims 1 and 3 of JP-A 2000-69697). In addition, the rotor magnets are arranged in recessed portions defined in a lower mold, whereby the rotor magnets are positioned at their respective desired positions (see paragraph of JP-A 2000-69697). With this method, however, a high-temperature resin comes into contact with the rotor magnets during a resin molding process. Therefore, an additional step of preheating the rotor magnets is necessary in order to prevent damage to the rotor magnets due to rapid heating.

### SUMMARY OF THE INVENTION

Preferred embodiments of the present invention provide a technique that achieves easy and highly accurate positioning of a plurality of magnets in an outer-rotor motor.

According to a first preferred embodiment of the present invention, a motor includes a stationary portion and a rotating portion supported to be rotatable with respect to the stationary portion. The rotating portion preferably includes a shaft arranged to extend along a central axis extending in a vertical direction; a rotor holder including a cylindrical portion arranged to be coaxial or substantially coaxial with the central axis; a plurality of magnets arranged in a circumferential direction on an inner circumferential surface of the cylindrical portion; and a resin portion arranged on a surface of the rotor holder. The stationary portion preferably includes a bearing portion arranged to rotatably support the shaft, and an armature arranged radially inward of the magnets. The resin portion preferably includes a plurality of ribs arranged at regular intervals in the circumferential direction along the inner circumferential surface of the cylindrical portion; and an outer tubular portion arranged to cover an outer circumferential surface of the cylindrical portion. Each rib and the outer tubular portion are preferably arranged to be continuous with each other by being defined by a single monolithic member. Each magnet is preferably arranged between a separate pair of adjacent ones of the ribs.

According to a second preferred embodiment of the present invention, a method of manufacturing a motor is provided, the motor preferably including a rotor holder including a cylindrical portion, a plurality of magnets arranged in a circumferential direction on an inner circumferential surface of the cylindrical portion, and a resin portion arranged on a surface of the rotor holder. The method preferably includes the steps of a) preparing the rotor holder, the rotor holder including through holes defined therein; b) after step a), molding the resin portion on the surface of the rotor holder; and c) after step b), attaching the magnets to the rotor holder and the resin portion. Step b) preferably includes a step of causing a resin to flow on both radially outer and radially inner sides of the cylindrical portion through the through holes to mold an outer tubular portion arranged to cover an outer circumferential surface of the cylindrical portion, and a plurality of ribs arranged at regular intervals in the circumferential direction along the inner circumferential surface of the cylindrical portion. Step c) preferably includes press fitting each of the magnets into a space defined between a separate pair of adjacent ones of the ribs.

According to the first preferred embodiment described above, it is possible to position the magnets easily and with high accuracy using the ribs.

According to the second preferred embodiment described above, the outer tubular portion and the ribs are preferably arranged to be defined as a single monolithic member such that the outer tubular portion and the ribs are continuous with each other through the through holes, whereby an improvement is achieved in strength with which each rib is fixed to the rotor holder. Moreover, it is possible to position the magnets easily and with high accuracy using the ribs. It is also possible to securely fix each magnet to the rotor holder.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a vertical cross-sectional view of a motor according to a preferred embodiment of the present invention.

FIG. 2 is a bottom view of a rotating portion according to a preferred embodiment of the present invention.

FIG. 3 is a vertical cross-sectional view of a motor according to a preferred embodiment of the present invention.

FIG. 4 is a bottom view of a rotating portion according to a preferred embodiment of the present invention.

FIG. 5 is a partial bottom view of the rotating portion.

FIG. 6 is a vertical cross-sectional view of the rotating portion taken along circumferential line VI-VI in FIG. 5.

FIG. 7 is a flowchart illustrating a procedure relating to molding of a resin portion and press fitting of magnets according to a preferred embodiment of the present invention.

FIG. 8 is a vertical cross-sectional view illustrating how the resin portion is molded according to a preferred embodiment of the present invention.

FIG. 9 is a perspective view illustrating how the press fitting of each magnet is carried out according to a preferred embodiment of the present invention.

FIG. 10 is a partial vertical cross-sectional view of a rotating portion according to a preferred embodiment of the present invention.

### DETAILED DESCRIPTION OF THE PREFERRED EMBODIMENTS

Hereinafter, preferred embodiments of the present invention will be described with reference to the accompanying drawings. It is assumed herein that a direction parallel or substantially parallel to a central axis is referred to by the term “axial direction”, “axial”, or “axially”, that directions perpendicular or substantially perpendicular to the central axis are referred to by the term “radial direction”, “radial”, or “radially”, and that a circumferential direction about the central axis is simply referred to by the term “circumferential direction”, “circumferential”, or “circumferentially”. It is also assumed herein that a vertical direction is defined as a direction in which a central axis of a motor extends, and that a side on which magnets are arranged with respect to a top plate portion of a rotor holder is defined as a lower side. The shape of each member or portion and relative positions of different members or portions will be described based on the above assumptions. It should be noted, however, that the above definitions of the vertical direction and the upper and lower sides are simply made for the sake of convenience in description, and should not be construed to restrict in any way the orientation of a motor according to any embodiment of the present invention when in actual use.

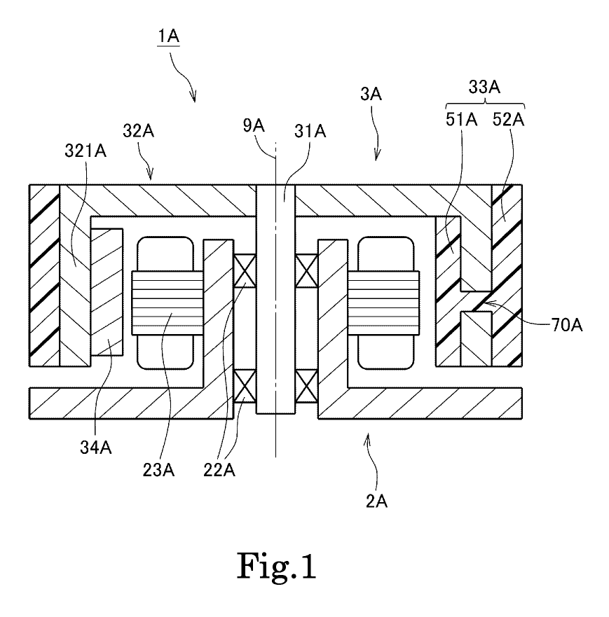

FIG. 1 is a vertical cross-sectional view of a motor 1A according to a preferred embodiment of the present invention. As illustrated in FIG. 1, the motor 1A includes a stationary portion 2A and a rotating portion 3A. The rotating portion 3A is supported to be rotatable with respect to the stationary portion 2A.

The stationary portion 2A preferably includes bearing portions 22A and an armature 23A. The bearing portions 22A are arranged to rotatably support a shaft 31A, which will be described below. The armature 23A is arranged radially inward of a plurality of magnets 34A, which will be described below.

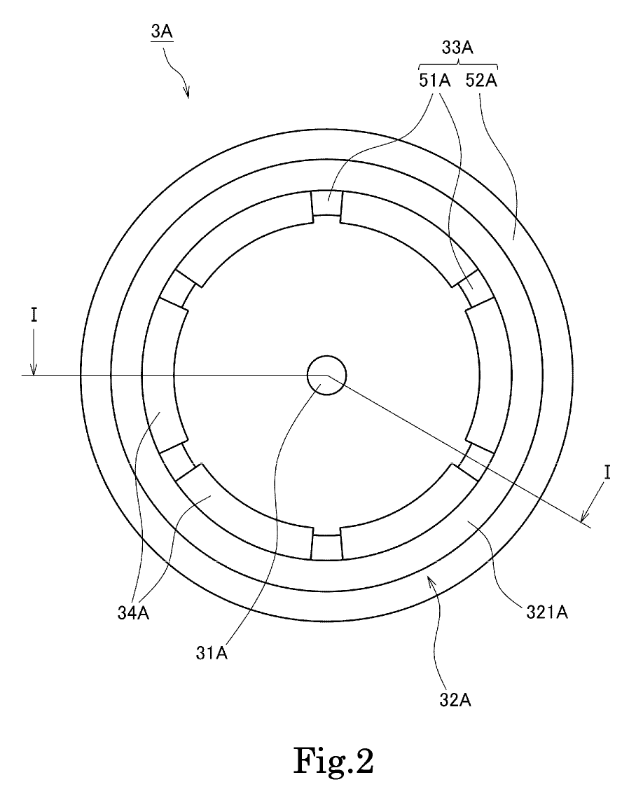

FIG. 2 is a bottom view of the rotating portion 3A. The rotating portion 3A illustrated in FIG. 1 corresponds to a cross-section of the rotating portion 3A taken along line I-I in FIG. 2. As illustrated in FIGS. 1 and 2, the rotating portion 3A preferably includes the shaft 31A, a rotor holder 32A, a resin portion 33A, and the magnets 34A.

The shaft 31A is arranged to extend along a central axis 9A. The rotor holder 32A preferably includes a cylindrical portion 321A arranged to be coaxial or substantially coaxial with the central axis 9A. The resin portion 33A is arranged on a surface of the rotor holder 32A. The magnets 34A are arranged in a circumferential direction on an inner circumferential surface of the cylindrical portion 321A.

The resin portion 33A preferably includes a plurality of ribs 51A and an outer tubular portion 52A. The ribs 51A are preferably arranged at regular intervals in the circumferential direction along the inner circumferential surface of the cylindrical portion 321A of the rotor holder 32A. The outer tubular portion 52A is arranged to cover an outer circumferential surface of the cylindrical portion 321A of the rotor holder 32A. The ribs 51A and the outer tubular portion 52A are arranged to be continuous with each other.

Each of the magnets 34A is arranged between a separate pair of adjacent ones of the ribs 51A. Each magnet 34A is thereby positioned at a desired position with high accuracy.

When the motor 1A is manufactured, the rotor holder 32A is preferably first prepared with through holes 70A defined therein. Next, the resin portion 33A is molded on the surface of the rotor holder 32A. At this time, a resin is caused to flow on both radially outer and inner sides of the cylindrical portion 321A while also flowing through the through holes 70A of the rotor holder 32A. As a result, the outer tubular portion 52A, which is arranged to cover the outer circumferential surface of the cylindrical portion 321A, and the ribs 51A, which are arranged at regular intervals in the circumferential direction along the inner circumferential surface of the cylindrical portion 321A, are molded. Since the outer tubular portion 52A and the ribs 51A are arranged to be continuous with each other through the through holes 70A, an improvement in strength with which each rib 51A is fixed to the rotor holder 32A is achieved.

Thereafter, the magnets 34A are attached to the rotor holder 32A and the resin portion 33A. Each of the magnets 34A is preferably, for example, press fitted into a space defined between a separate pair of adjacent ones of the ribs 51A. Each magnet 34A is thereby positioned at the desired position easily and with high accuracy. Moreover, each magnet 34A is thereby securely fixed to the rotor holder 32A.

Next, a more specific preferred embodiment of the present invention will now be described below.

A motor according to the present preferred embodiment is preferably a fan motor arranged to produce air currents for cooling purposes, for example, and which may be installed in a variety of devices. Note, however, that motors according to preferred embodiments of the present invention may also be used in applications other than fans if so desired. Motors according to preferred embodiments of the present invention may, for example, be used in transportation apparatuses, such as automobiles, household electrical appliances, office automation appliances, medical appliances, or the like, to generate a variety of driving forces.

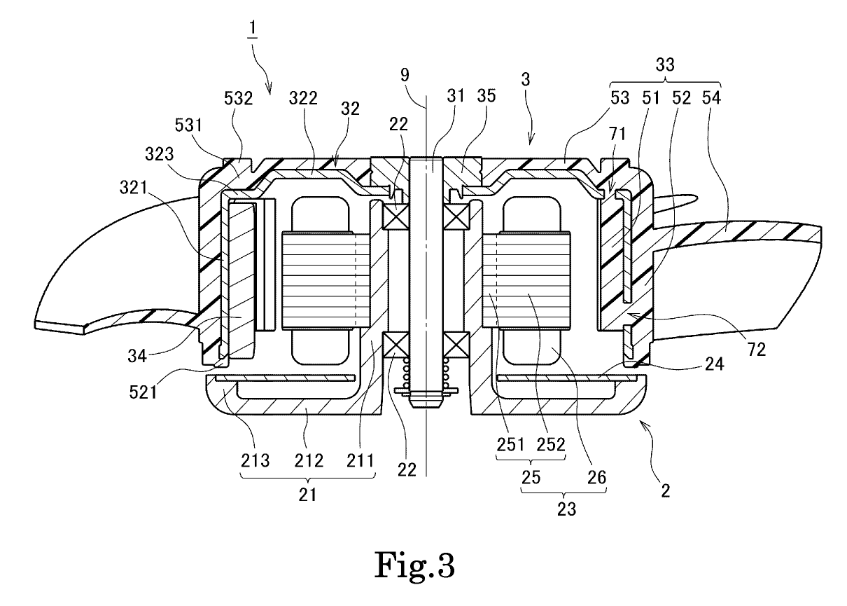

FIG. 3 is a vertical cross-sectional view of a motor 1 according to the present preferred embodiment. As illustrated in FIG. 3, the motor 1 includes a stationary portion 2 and a rotating portion 3. The stationary portion 2 is fixed to a frame of an apparatus for which the motor 1 is driven. The rotating portion 3 is supported to be rotatable with respect to the stationary portion 2.

The stationary portion 2 according to the present preferred embodiment preferably includes a base member 21, bearing portions 22, an armature 23, and a circuit board 24.

The base member 21 is arranged to hold the bearing portions 22, the armature 23, and the circuit board 24. The base member 21 may be made either of a metal, such as, for example, aluminum, or of another suitable material, such as, for example, resin. The base member 21 preferably includes a bearing support portion 211, a bottom portion 212, and an annular rest portion 213. The bearing support portion 211 is a substantially cylindrical portion arranged to surround a central axis 9. The bottom portion 212 is a substantially flat plate-shaped portion arranged to extend radially outward from a lower end portion of the bearing support portion 211. The annular rest portion 213 is arranged to project upward from a radially outer edge portion of the bottom portion 212.

The bearing portions 22 are arranged to rotatably support a shaft 31, which is included in the rotating portion 3. Each bearing portion 22 is preferably held by an inner circumferential surface of the bearing support portion 211 of the base member 21. A ball bearing, which is arranged to cause outer and inner races to rotate relative to each other through balls, for example, is used as each bearing portion 22. Note that other types of bearings, such as, for example, a plain bearing, a fluid bearing, etc., may be used instead of the ball bearings if so desired.

The armature 23 preferably includes a stator core 25 and coils 26. The stator core 25 according to the present preferred embodiment is preferably defined by laminated steel sheets, i.e., electromagnetic steel sheets, such as, for example, silicon steel sheets, placed one upon another in an axial direction. However, any other desirable type of stator core could be used instead. The stator core 25 preferably includes an annular core back 251 and a plurality of teeth 252. The teeth 252 are arranged to project radially outward from the core back 251. The core back 251 is fixed to an outer circumferential surface of the bearing support portion 211 of the base member 21. The teeth 252 are arranged at regular intervals in the circumferential direction. Each of the coils 26 is wound around a separate one of the teeth 252.

The circuit board 24 is a board on which an electronic circuit configured to supply drive currents to the coils 26 is mounted. The circuit board 24 is preferably arranged below the armature 23 and a plurality of magnets 34, which will be described below. An outer circumferential portion of the circuit board 24 is fixed to an upper surface of the annular rest portion 213 of the base member 21.

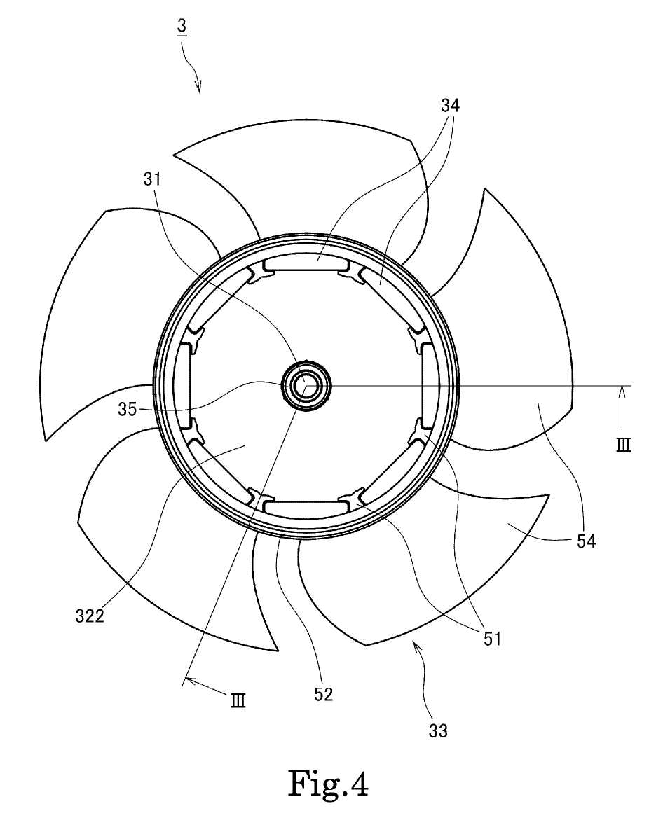

FIG. 4 is a bottom view of the rotating portion 3. The rotating portion 3 illustrated in FIG. 3 corresponds to a cross-section taken along line III-III in FIG. 4. As illustrated in FIGS. 3 and 4, the rotating portion 3 according to the present preferred embodiment preferably includes the shaft 31, a rotor holder 32, a resin portion 33, and the magnets 34.

The shaft 31 is a substantially columnar member arranged to extend in a vertical direction along the central axis 9. The shaft 31 is preferably made of a metal, such as, for example, stainless steel. The shaft 31 is arranged to rotate about the central axis 9 while being supported by the bearing portions 22. An annular bushing 35 is preferably attached to an upper end portion of the shaft 31.

The rotor holder 32 is preferably a metallic member arranged to rotate together with the shaft 31. The rotor holder 32 preferably includes a cylindrical portion 321 and a top plate portion 322. The cylindrical portion 321 is arranged radially outward of the armature 23, and arranged to be coaxial or substantially coaxial with the central axis 9. The top plate portion 322 is arranged to extend radially inward from an upper end portion of the cylindrical portion 321. In the present preferred embodiment, an inner circumferential portion of the top plate portion 322 preferably is fixed to the shaft 31 through the bushing 35. Note that the inner circumferential portion of the top plate portion 322 may be directly fixed to the shaft 31.

The resin portion 33 is preferably made of a molding-use resin, such as, for example, polycarbonate. The resin portion 33 is arranged on a surface of the rotor holder 32 through, for example, insert molding. As illustrated in FIGS. 3 and 4, the resin portion 33 preferably includes a plurality of ribs 51, an outer tubular portion 52, a top layer portion 53, and an impeller including a plurality of blades 54. The ribs 51 are arranged on an inner circumferential surface of the cylindrical portion 321 of the rotor holder 32. The outer tubular portion 52 is arranged to cover an outer circumferential surface of the cylindrical portion 321 of the rotor holder 32. The top layer portion 53 is arranged to cover an upper surface of the top plate portion 322 of the rotor holder 32. The blades are arranged in the circumferential direction radially outward of the outer tubular portion 52.

Each of the magnets 34 is preferably arranged between a separate pair of adjacent ones of the ribs 51 on the inner circumferential surface of the cylindrical portion 321 of the rotor holder 32. Each magnet 34 is, for example, preferably made of a sintered material containing ferrite as a main component. Note that another magnetic material, such as, for example, neodymium, may be used in place of ferrite if so desired. Also note that bonded magnets may be used instead of sintered magnets. A radially inner surface of each magnet 34 defines a pole surface arranged to be opposed to radially outer end surfaces of the teeth 252. The magnets 34 are arranged at regular intervals in the circumferential direction in such a manner that north and south pole surfaces alternate with each other.

Once the drive currents are supplied to the coils 26 through the circuit board 24, radial magnetic flux is generated around each of the teeth 252 of the stator core 25. Then, interaction between the magnetic flux of the teeth 252 and that of the magnets 34 produces a circumferential torque, so that the rotating portion 3 is caused to rotate about the central axis 9 with respect to the stationary portion 2. Rotation of the rotating portion 3 causes the impeller including the blades 54 to accelerate an air in the vicinity of the motor 1 to produce axial air currents.

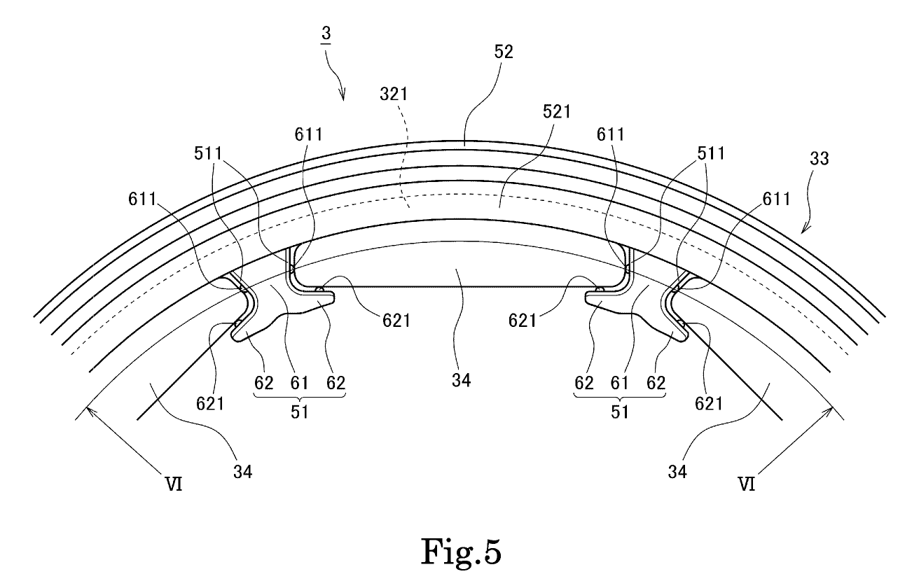

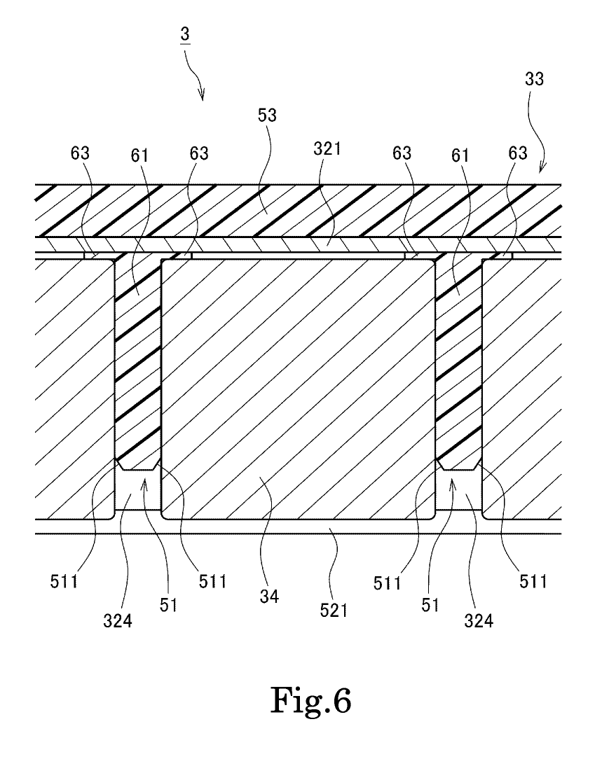

FIG. 5 is a partial bottom view of the rotating portion 3. FIG. 6 is a vertical cross-sectional view of the rotating portion 3 taken along circumferential line VI-VI in FIG. 5. More detailed structures of the rotor holder 32, the resin portion 33, and the magnets 34 will now be described below with reference to FIGS. 3 to 6.

As described above, the resin portion 33 includes the plurality of ribs 51. The ribs 51 are arranged at regular intervals in the circumferential direction on the inner circumferential surface of the cylindrical portion 321 of the rotor holder 32. Each rib 51 preferably includes a pillar portion 61 arranged to extend in the axial direction along the inner circumferential surface of the cylindrical portion 321, and wall portions 62 each arranged to extend in the circumferential direction from a radially inner end portion of the pillar portion 61.

Each magnet 34 is arranged in a pocket-like space defined between the pillar portions 61 of a separate pair of adjacent ones of the ribs 51, the wall portions 62 of the adjacent ribs 51, and the rotor holder 32. The pillar portions are arranged between the magnets 34 to regulate the circumferential positions of the magnets 34. According to the present preferred embodiment, each magnet 34 is preferably, for example, press fitted to the pillar portions 61, the wall portions 62, and the cylindrical portion 321 of the rotor holder 32. The magnets 34 are thereby securely fixed to the rotor holder 32 and the ribs 51.

Both circumferential end portions of each magnet 34 are preferably arranged to be in contact with the pillar portions 61 of the adjacent ribs 51. Each magnet 34 is thereby positioned in the circumferential direction with high accuracy. Moreover, the radially inner surface of each magnet 34 is arranged to be in contact with the wall portions 62 in the vicinity of each circumferential end portion of the magnet 34. Furthermore, a radially outer surface of each magnet 34 is arranged to be in contact with the inner circumferential surface of the cylindrical portion 321 of the rotor holder 32. Each magnet 34 is thereby positioned in a radial direction with high accuracy.

To be more precise, as illustrated in FIG. 5, a first projection 611 extending in the axial direction is preferably arranged on each side surface of each pillar portion 61, and both the circumferential end portions of each magnet 34 are arranged to be in contact with the first projections 611. In addition, a second projection 621 extending in the axial direction is preferably arranged on a radially outer surface of each wall portion 62, and the radially inner surface of each magnet 34 is arranged to be in contact with the second projection 621 in the vicinity of each circumferential end portion of the magnet 34. The total area of contact between each magnet 34 and each adjacent rib 51 is thereby decreased, so that the, for example, press fitting operation for the magnet 34 is made easier.

During driving of the motor 1, strong magnetic attraction forces act between the magnets 34 and the teeth 252.

However, in the present preferred embodiment, the wall portions 62 are arranged radially inward of both the circumferential end portions of each magnet 34. In other words, each magnet 34 and the wall portions 62 are arranged to partially overlap with each other in the radial direction. Each magnet 34 is thereby prevented from moving radially inward.

Referring to FIGS. 3 and 6, in the present preferred embodiment, a lower end portion of each rib 51 preferably does not extend up to a lower end portion of the cylindrical portion 321 of the rotor holder 32. In other words, the lower end portion of each rib 51 is arranged at a level higher than that of the lower end portion of the cylindrical portion 321. The inner circumferential surface of the cylindrical portion 321 includes an annular region 324 arranged below the ribs 51 and on which no portions of the ribs 51 are arranged. In a procedure of manufacturing the motor 1, which will be described below, an adhesive is preferably applied to this annular region 324.

Referring to FIGS. 5 and 6, each of the ribs 51 according to the present preferred embodiment preferably includes tapered surfaces 511. The tapered surfaces 511 are defined in lower end portions of circumferential side surfaces of each pillar portion 61, and in a lower end portion of the radially outer surface of each wall portion 62. Each tapered surface 511 is preferably inclined so as to gradually approach an adjacent one of the magnets 34 with increasing height. In the press fitting operation for the magnets 34, for example, the tapered surfaces 511 guide each magnet 34 into the space defined between a separate pair of adjacent ones of the ribs 51.

In addition, referring to FIG. 6, in the present preferred embodiment, an upper end portion of each rib 51 includes top wall portions 63 arranged to extend along a lower surface of the top plate portion 322, and an upper end surface of each magnet 34 is arranged to be in contact with lower surfaces of the top wall portions 63. That is, the top wall portions 63 are held between the lower surface of the top plate portion 322 and the upper end surfaces of the magnets 34. A gap is thereby secured between the lower surface of the top plate portion 322 and the upper end surface of each magnet 34 above which no portion of any top wall portion 63 is held. In general, reluctance is generated in gaps (spaces). Therefore, the aforementioned gap contributes to preventing leakage of magnetic flux from the magnet 34 to the top plate portion 322. Note, however, that the top wall portions 63 adjacent to each other in the circumferential direction may alternatively be continuously defined without the aforementioned gap if so desired.

In addition, referring to FIG. 3, the rotor holder 32 according to the present preferred embodiment includes a plurality of first through holes 71 and a plurality of second through holes 72. Each first through hole 71 is preferably arranged to extend through the top plate portion 322 in the axial direction. Each second through hole 72 is preferably arranged to extend through the cylindrical portion 321 in the radial direction. Both the first through holes 71 and the second through holes 72 are arranged in the circumferential direction and at circumferential positions corresponding to those of the ribs 51.

In the present preferred embodiment, the resin portion 33 is arranged on both an inner side and an outer side of the rotor holder 32. The ribs 51 and the top layer portion 53 are preferably arranged to be defined by a single monolithic member such that the ribs 51 and the top layer portion 53 are continuous with each other through the first through holes 71. In addition, the ribs 51 and the outer tubular portion 52 are also preferably arranged to be defined by a single monolithic member such that the ribs 51 and the outer tubular portion 52 are continuous with each other through the second through holes 72. The rotor holder 32 and the resin portion 33 are thereby securely fixed to each other.

In particular, in the present preferred embodiment, each rib 51 is arranged to be continuous with the top layer portion 53 and the outer tubular portion 52 at an upper position and at a lower position, respectively. Accordingly, a strength of each rib 51 is thereby increased. This makes it possible to, for example, press fit each magnet 34 into the space defined between the adjacent ribs 51 while avoiding or substantially avoiding undesirable deformation of the ribs 51.

In addition, in the present preferred embodiment, a radially inner edge portion of the top layer portion 53 is arranged to be in contact with the bushing 35. That is, the top plate portion 322 of the rotor holder 32, the top layer portion 53 of the resin portion 33, and the bushing 35 are fixed to one another while being in contact with one another. This arrangement contributes to increasing the strength with which the rotor holder 32, the resin portion 33, and the bushing 35 are fixed to one another.

In addition, in the present preferred embodiment, the top plate portion 322 of the rotor holder 32 includes an annular recessed portion 323 defined in the vicinity of an outer circumferential portion thereof and recessed downward. The first through holes 71 are defined in this annular recessed portion 323. Thus, a large space is secured above each first through hole 71 in an insert molding step described below. This space contributes to improving fluidity of the resin passing through the first through hole 71.

The top layer portion 53 preferably includes an increased thickness portion 531 arranged above the annular recessed portion 323 and having a greater thickness than that of a remaining portion of the top layer portion 53. In the present preferred embodiment, a raised portion 532 is preferably defined in an upper surface of the increased thickness portion 531. Thus, it is possible to attach a correcting member to the raised portion 532 to correct a displaced center of gravity of the rotating portion 3. Note that a recessed portion, in place of the raised portion 532, may alternatively be defined in the upper surface of the increased thickness portion 531 so that the correcting member can be attached to an inside of the recessed portion.

In addition, during driving of the motor 1, a radially outward centrifugal force acts on the lower end portion of the cylindrical portion 321 of the rotor holder 32. In view of this consideration, in the present preferred embodiment, a lower edge portion 521 of the outer tubular portion 52 is preferably arranged to cover the lower end portion of the cylindrical portion 321 of the rotor holder 32. Strength of the lower end portion of the cylindrical portion 321 and its vicinity is thereby increased. Thus, a radially outward bend of the lower end portion of the cylindrical portion 321 and its vicinity due to the centrifugal force is prevented more effectively.

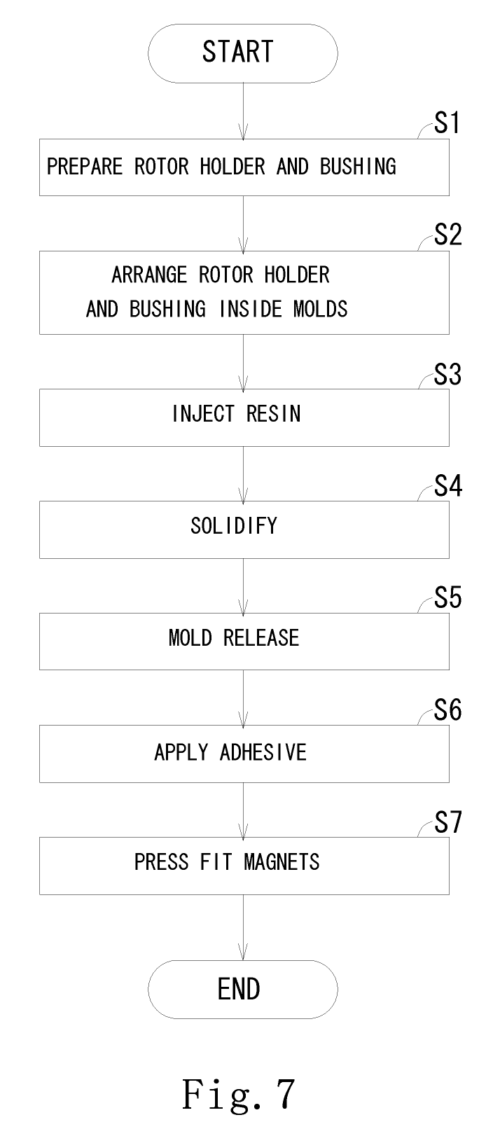

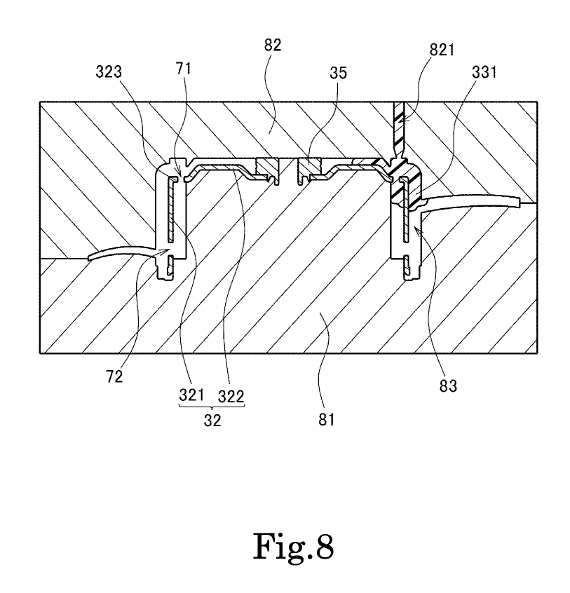

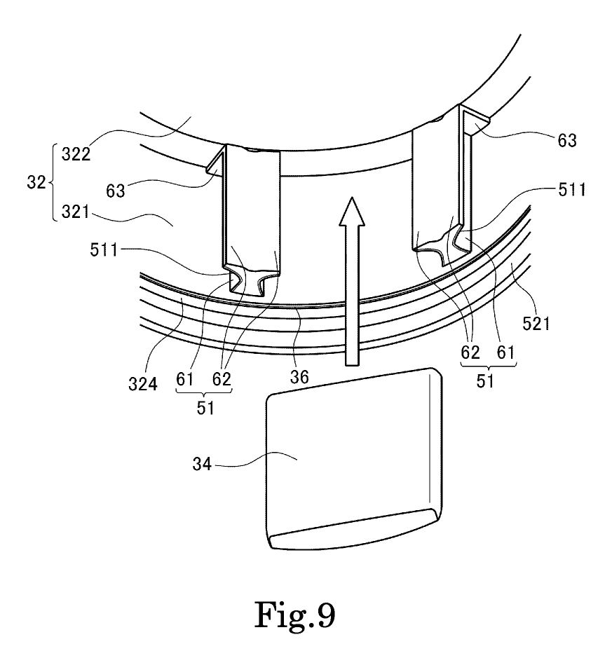

Next, an exemplary procedure relating to molding of the resin portion 33 and press fitting of the magnets 34, that are usable within the procedure of manufacturing the motor 1 described above, will now be described below with reference to FIGS. 7, 8, and 9. FIG. 7 is a flowchart illustrating the procedure relating to the molding of the resin portion 33 and the press fitting of the magnets 34. FIG. 8 is a vertical cross-sectional view illustrating how the resin portion 33 is molded. FIG. 9 is a perspective view illustrating how the press fitting of each magnet 34 is carried out.

When the resin portion 33 is molded, the rotor holder 32 and the bushing 35 are first prepared (step S1). The first through holes 71 have preferably been previously defined in the top plate portion 322 of the rotor holder 32. In addition, the second through holes 72 have been previously defined in the cylindrical portion 321 of the rotor holder 32. The bushing 35 is fixed to the inner circumferential portion of the top plate portion 322 of the rotor holder 32 by crimping. Each of the rotor holder 32 and the bushing 35 may be produced either by a manufacturer of the motor 1 itself or by another party.

Next, a pair of molds 81 and 82 which match the shapes of the rotor holder 32, the bushing 35, and the resin portion 33 to be molded are prepared. Then, the rotor holder 32 having the bushing 35 attached thereto is set on the mold 81. Thereafter, an upper side of the mold 81 is closed with the other mold 82. As a result, a cavity 83 is defined inside the molds 81 and 82, with the rotor holder 32 having the bushing 35 attached thereto arranged in the cavity 83 (step S2).

Next, as illustrated in FIG. 8, a resin 331 in a fluid state is injected into the cavity 83 inside the molds 81 and 82 (step S3). Here, as illustrated in FIG. 8, the resin 331 in the fluid state is injected into the cavity 83 inside the molds 81 and 82 through a runner 821 defined in the mold 82. A region above the top plate portion 322 of the rotor holder 32 and a region radially outside the cylindrical portion 321 are filled with the resin 331. The first and second through holes 71 and 72 are also filled with the resin 331. Further, the resin 331 passes through each of the first and second through holes 71 and 72 to fill a region radially inside the cylindrical portion 321. That is, both a region on a radially outer side of the cylindrical portion 321 and a region on a radially inner side of the cylindrical portion 321 are filled with the resin 331.

In particular, in the present preferred embodiment, the first through holes 71 are defined in the annular recessed portion 323 of the rotor holder 32. Therefore, a relatively large space is secured above each first through hole 71. Because this space has a small channel resistance, a smooth flow of the resin 331 into the first through hole 71 is achieved. The resin 331 is thus allowed to flow smoothly through each first through hole 71 downwardly of the annular recessed portion 323.

After the resin 331 spreads through the cavity 83 inside the molds 81 and 82, the resin 331 inside the molds 81 and 82 is cooled and thereby solidified (step S4). As a result of being solidified, the resin 331 inside the molds 81 and 82 defines the resin portion 33 including the ribs 51, the outer tubular portion 52, and the top layer portion 53. Moreover, as a result of solidification of the resin 331, the resin portion 33 is fixed to the surface of the rotor holder 32. The ribs 51 are arranged to be continuous with the top layer portion 53 and the outer tubular portion 52 through the first and second through holes 71 and 72, respectively. The resin portion 33 is thereby securely fixed to the rotor holder 32.

Thereafter, the molds 81 and 82 are opened, and the resin portion 33, the rotor holder 32, and the bushing 35 are released from the molds 81 and 82 (step S5). Steps S1 to S5 described above together define an exemplary procedure of insert molding. In the insert molding, the molding of the resin portion 33 and the fixing of the resin portion 33 to the rotor holder 32 and the bushing 35 are simultaneously accomplished. The procedure of manufacturing the motor 1 is thus shortened as compared to a case where the molding and the fixing of the resin portion 33 are separately carried out.

After the insert molding is completed, an adhesive 36 is preferably applied to the inner circumferential surface of the cylindrical portion 321 of the rotor holder 32 (step S6). In this step, a nozzle through which the adhesive 36 is injected is first arranged at a position close to the region 324 on the inner circumferential surface of the cylindrical portion 321. The region 324 is arranged below the lower end portions of the ribs 51. Then, the rotor holder 32 is caused to rotate while the adhesive 36 is injected through the nozzle. As a result, as illustrated in FIG. 9, the adhesive 36 is applied to the inner circumferential surface of the cylindrical portion 321 such that the adhesive 36 is arranged thereon in an annular shape.

Next, the magnets 34 are prepared, and each magnet 34 is press fitted to the rotor holder 32 and the resin portion 33 (step S7). Here, as illustrated in FIG. 9, each magnet 34 is press fitted from below into the space defined between a separate pair of adjacent ones of the ribs 51. Each magnet 34 is positioned in both circumferential and radial directions through the ribs 51. In particular, in the present preferred embodiment, the tapered surfaces 511 are preferably defined in a lower surface of each rib 51. Therefore, even if the magnet 34 is set at a slightly displaced position, the magnet 34 can be guided into the space defined between the pillar portions 61 of the adjacent ribs 51 and radially outside the wall portions 62 of the ribs 51, by moving an upper end portion of the magnet 34 along the tapered surfaces 511 of the ribs 51. The magnet 34 is thereby positioned with high accuracy in both circumferential and radial directions.

In addition, each of the ribs 51 according to the present preferred embodiment preferably includes the first projections 611 arranged on the side surfaces of the pillar portion 61 thereof, and the second projections 621 arranged on the radially outer surfaces of the wall portions 62 thereof. Each magnet 34 is press fitted while being in contact with the first and second projections 611 and 621. The area of contact between the magnet 34 and each of the adjacent ribs 51 is thus decreased to facilitate the operation of press fitting the magnet 34.

Each magnet 34 is preferably pushed in until the upper end portion of the magnet 34 comes into contact with the top wall portions 63. Once the press fitting of the magnet 34 is completed, the magnet 34 is fixed to the rotor holder 32 and the adjacent ribs 51 through both a fastening force due to the press fitting and an adhesive force due to the adhesive 36.

### Example Modifications of Preferred Embodiments

While preferred embodiments of the present invention have been described above, it should be understood that the present invention is not limited to the above-described preferred embodiments.

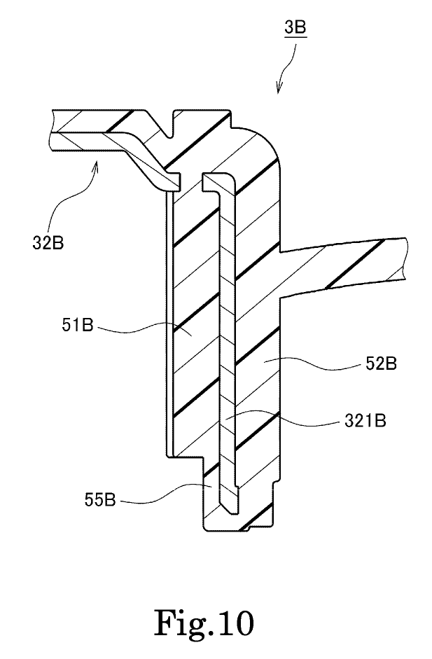

FIG. 10 is a partial vertical cross-sectional view of a rotating portion 3B according to a modification of one of the above-described preferred embodiments. In an example of FIG. 10, a resin layer 55B is defined below ribs 51B. The resin layer 55B has a smaller radial thickness than that of each rib 51B. When the thickness of the resin layer 55B is set at a value that does not cause interference between the resin layer 55B and the nozzle through which the adhesive is injected, it is possible to apply the adhesive to the resin layer 55B in the annular shape as in step S6 described above.

In addition, in the example of FIG. 10, each rib 51B and the resin layer 55B are preferably provided by a single monolithic member such that each rib 51B and the resin layer 55B are continuous with an outer tubular portion 52B through a lower end portion of a cylindrical portion 321B of a rotor holder 32B. Each rib 51B is thus securely fixed to the rotor holder 32B without a need to define second through holes in the cylindrical portion 321B of the rotor holder 32B.

In short, in order to securely fix the ribs to the rotor holder, it is desirable that the ribs and the outer tubular portion should be arranged as a single monolithic member to be continuous with each other through the surface of the rotor holder. As an exemplary way to achieve the above, the ribs and the outer tubular portion may be arranged to be continuous with each other through the through holes defined in the rotor holder. As another exemplary way to achieve the above, the ribs and the outer tubular portion may be arranged to be defined by a single monolithic member to be continuous with each other through the lower end portion of the cylindrical portion.

Note that the outer circumferential surface of the cylindrical portion of the rotor holder may be covered with the outer tubular portion either entirely or only partially if so desired. Also note that the upper surface of the top plate portion of the rotor holder may be covered with the top layer portion either entirely or only partially. Also note that the top layer portion may not necessarily be arranged on the upper surface of the top plate portion of the rotor holder.

The shape of each rib is not limited to the examples described above, but a variety of other shapes may be adopted for each rib. For example, the tapered surface(s) may be defined in only either the lower end portion of each pillar portion or the lower end portion of each wall portion. Also note that one or more of the wall portions, the top wall portions, the tapered surfaces, the first projections, and the second projections may be omitted. Also note that each of the number of ribs and the number of magnets is not limited to the example described above.

Also note that each magnet may not necessarily be press fitted into the space defined between a separate pair of adjacent ones of the ribs. That is, the ribs may be used only for the sake of positioning the magnets without contributing to increasing strength with which each magnet is fixed to the rotor holder. In this case, each magnet may be fixed to the rotor holder only through the adhesive force of the adhesive.

Also note that each magnet may be fixed to the rotor holder only through the fastening force due to the press fitting without use of the adhesive if so desired.

Also note that the detailed shape of any portion of the motor may not necessarily correspond with that illustrated in the accompanying figures.

Also note that features of any of the above-described preferred embodiments and the modifications thereof may be combined appropriately as long as no conflict arises.

Preferred embodiments of the present invention are applicable to motors and methods of manufacturing the motors.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A motor comprising:
a stationary portion; and
a rotating portion supported to be rotatable with respect to the stationary portion; wherein
the rotating portion includes:
a shaft arranged to extend along a central axis extending in a vertical direction;
a rotor holder including a cylindrical portion arranged to be coaxial with the central axis;
a plurality of magnets arranged in a circumferential direction on an inner circumferential surface of the cylindrical portion; and
a resin portion arranged on a surface of the rotor holder;
the stationary portion includes:
a bearing portion arranged to rotatably support the shaft; and
an armature arranged radially inward of the magnets;
the resin portion includes:
a plurality of ribs arranged at regular or substantially regular intervals in the circumferential direction along the inner circumferential surface of the cylindrical portion; and
an outer tubular portion arranged to cover an outer circumferential surface of the cylindrical portion;
each rib and the outer tubular portion are arranged to be continuous with each other; and
each magnet is arranged between a separate pair of adjacent ones of the ribs.

2. The motor according to claim 1, wherein each rib and the outer tubular portion are defined by a single monolithic member such that each rib and the outer tubular portion are continuous with each other through the surface of the rotor holder.

3. The motor according to claim 1, wherein both circumferential end portions of each magnet are arranged to be in contact with the adjacent ribs.

4. The motor according to claim 1, further comprising projections arranged on and along each rib, wherein both circumferential end portions of each magnet are arranged to be in contact with the projections.

5. The motor according to claim 1, wherein each rib includes:
a pillar portion arranged to extend in an axial direction between the adjacent magnets; and
wall portions each arranged to extend in the circumferential direction from a radially inner end portion of the pillar portion, and each arranged to overlap with a separate one of the adjacent magnets in a radial direction.

6. The motor according to claim 5, wherein each rib further includes at least one of first tapered surfaces defined in a lower end portion of the pillar portion and each arranged to gradually approach a separate one of the adjacent magnets with increasing height, and second tapered surfaces each defined in a lower end portion of a separate one of the wall portions and each arranged to gradually approach a separate one of the adjacent magnets with increasing height.

7. The motor according to claim 1, wherein the inner circumferential surface of the cylindrical portion includes a region arranged below the ribs and on which no portions of the ribs are arranged, or a region arranged below the ribs and on which a resin layer having a smaller radial thickness than that of each rib is arranged; and
the region has an adhesive applied thereto.

8. The motor according to claim 1, wherein the rotor holder further includes a top plate portion arranged to extend radially inward from an upper end portion of the cylindrical portion, and directly or indirectly fixed to the shaft.

9. The motor according to claim 8, wherein the resin portion further includes a top layer portion arranged to cover an upper surface of the top plate portion.

10. The motor according to claim 9, wherein
the top plate portion includes a plurality of first through holes defined therein; and
the top layer portion and the ribs are arranged to be defined by a single monolithic member such that the top layer portion and the ribs are continuous with each other through the first through holes.

11. The motor according to claim 10, wherein
the top plate portion includes an annular recessed portion defined in a vicinity of an outer circumferential portion thereof and recessed downward; and
the first through holes are defined in the annular recessed portion.

12. The motor according to claim 10, wherein each of the first through holes is arranged at a position corresponding to that of a separate one of the ribs.

13. The motor according to claim 9, wherein an upper surface of the top layer portion includes an annular raised or annular recessed portion.

14. The motor according to claim 8, wherein
the resin portion includes top wall portions arranged to extend from an upper end portion of each rib along a lower surface of the top plate portion; and
each top wall portion is held between the lower surface of the top plate portion and an upper end surface of one of the magnets.

15. The motor according to claim 1, wherein
the cylindrical portion includes a plurality of second through holes defined therein; and
the outer tubular portion and the ribs are arranged to be defined by a single monolithic member such that the outer tubular portion and the ribs are continuous with each other through the second through holes.

16. The motor according to claim 15, wherein each of the second through holes is arranged at a position corresponding to that of a separate one of the ribs.

17. The motor according to claim 1, wherein the resin portion further includes a lower edge portion arranged to cover a lower end portion of the cylindrical portion.

18. The motor according to claim 1, wherein the resin portion further includes an impeller arranged radially outward of the outer tubular portion.

19. A method of manufacturing a motor including a rotor holder including a cylindrical portion, a plurality of magnets arranged in a circumferential direction on an inner circumferential surface of the cylindrical portion, and a resin portion arranged on a surface of the rotor holder, the method comprising the steps of:
a) preparing the rotor holder, the rotor holder including through holes defined therein;
b) after step a), molding the resin portion on a surface of the rotor holder; and
c) after step b), attaching the magnets to the rotor holder and the resin portion; wherein
step b) includes causing a resin to flow on both radially outer and inner sides of the cylindrical portion through the through holes to mold an outer tubular portion arranged to cover an outer circumferential surface of the cylindrical portion, and a plurality of ribs arranged at regular or substantially regular intervals in the circumferential direction along the inner circumferential surface of the cylindrical portion; and
step c) includes press fitting each of the magnets into a space defined between a separate pair of adjacent ones of the ribs.

20. The method according to claim 19, wherein
the rotor holder further includes a top plate portion arranged to extend radially inward from an upper end portion of the cylindrical portion;
the through holes of the rotor holder prepared in step a) include first through holes defined in the top plate portion, and second through holes defined in the cylindrical portion; and
in step b), each of the first and second through holes is filled with the resin so that the resin portion is molded with the outer tubular portion and each rib define a single monolithic member such that the outer tubular portion and the ribs are continuous with each other.
